(19) United States
(12) Patent Application Publication
(10) Pub. No.: US 2015/0097813 A1
(43) Pub. Date: Apr. 9, 2015

(54) OPTICAL TOUCH PANEL DEVICE AND RECORDING MEDIUM

(71) Applicant: Sharp Kabushiki Kaisha, Osaka-shi, Osaka (JP)

(72) Inventor: Koichi Sugiyama, Osaka-shi (JP)

(21) Appl. No.: 14/391,234

(22) PCT Filed: Apr. 9, 2013
(86) PCT No.: PCT/JP2013/060663

§ 371 Date: Oct. 8, 2014

(30) Foreign Application Priority Data
Apr. 10, 2012 (JP) 2012-089658

(51) Int. Cl. G06F 3/041; G06F 3/0488; G06F 3/0482; G06F 3/042; G06F 3/0484

(52) U.S. Cl. CPC G06F 3/0416; G06F 3/0421; G06F 3/04847; G06F 3/0482; G06F 3/0488
USPC 345/175

(57) ABSTRACT

The optical touch panel device can optically detect a position of an object on a display screen at a plurality of kinds of position-detection resolutions, and sets a position-detection resolution according to a screen resolution of the display screen or an image resolution of an image to be displayed on the display screen. The optical touch panel device sets the position-detection resolution so that an average value of distances between optical paths used for position detection over the whole display screen is smaller than a dot pitch or a pixel pitch and is as close as possible to the dot pitch or the pixel pitch. The capability of position detection matches the capability of image display in the optical touch panel device, thereby user does not have a feeling of strangeness about an image displayed according to position-detection resolution.

This application is the national phase under 35 U.S.C. §371 of PCT International Application No. PCT/JP2013/060663 which has an International filing date of Apr. 9, 2013 and designated the United States of America.

### BACKGROUND

1. Technical Field

The present invention relates to an optical touch panel device which detect a position optically and a recording medium.

2. Description of Related Art

As one of the touch panel devices used conventionally, there is an optical touch panel device. An example of the optical touch panel device is disclosed in Japanese Patent Application Laid-Open No. 2002-91683. In the optical touch panel device, a plurality of light emitting devices are arranged along sides of a rectangular display screen in an X-axis direction and a Y-axis direction, and a plurality of light receiving devices are arranged at positions facing the light emitting devices arranged along the sides of the display screen. Light emitted by the light emitting device travels along the display screen, and is received by the light receiving device. When a user puts a light shielding object, such as a finger or a pen, on the display screen, there is the light receiving device(s) which cannot receive light, since the light is blocked by the light shielding object. The optical touch panel device identifies a position of the light receiving device which cannot receive light among the light receiving devices arranged in the X-axis direction and the Y-axis direction, thereby detects a position of the light shielding object put on the display screen.

The light emitting devices and the light receiving devices of the optical touch panel device are arranged so that they face each other on a one-to-one basis. As a method for detecting a position by the optical touch panel device, there are a whole scan method for scanning the whole display screen in order to detect a position of a light shielding object, and an intensive scan method for scanning an area around the light shielding object intensively. In the whole scan method, the optical touch panel device causes a plurality of light emitting devices to sequentially emit light from one end to the other end in the X-axis direction and the Y-axis direction, and causes light receiving devices facing the light emitting devices on the one-to-one basis to receive light. Light emitted from one light emitting device is received by one light receiving device, and optical paths of light received by a plurality of light receiving devices aligned in one axial direction are parallel to each other. A position-detection resolution is determined according to a distance between adjacent light emitting devices.

In the intensive scan method, the optical touch panel device receives light emitted from one light emitting device by a plurality of light receiving devices. Optical paths of light received by the plurality of light receiving devices are radial optical paths radially extending from the one light emitting device as a starting point. Since a density of optical paths used for position detection is high, a position-detection resolution of the intensive scan method is higher than a position-detection resolution of the whole scan method. The larger the number of light receiving devices which receive light emitted from one light emitting device is, the higher the position-detection resolution is.

As the optical touch panel device, there is a device which displays a locus of a light shielding object as an image in a display screen. In such an optical touch panel device, a user can write a character or a drawing on the display screen using a light shielding object such as a pen. Also, it is possible that the optical touch panel device displays an image inputted from the outside and a user writes it so as to overlap the displayed image.

### SUMMARY OF THE INVENTION

When there is a difference between a position-detection resolution of an optical touch panel device and a resolution of an image to be displayed on a display screen, there is a problem that a capability of position detection does not match a capability of image display. For example, in a case where a resolution of an image is high and a position-detection resolution is low, detected positions of a light shielding object may be discontinuous or jagged, and an image corresponding to a written portion can be displayed only at a resolution according to a position-detection resolution and cannot be displayed at a high resolution. For this reason, a user has a feeling of strangeness about an image displayed at a high resolution and an image of a written portion displayed at a low resolution. Moreover, in a case where a resolution of an image is low and a position-detection resolution is high, most information on positions of a light shielding object detected at a high resolution will be useless without being reflected on an image to be displayed. For this reason, even when the number of light receiving devices which receive light emitted from one light emitting device is increased to obtain a high position-detection resolution, power consumption is increased carelessly and a response time is prolonged, thereby causing inconvenience to a user.

The present invention has been made in consideration of such a situation, and an object thereof is to provide an optical touch panel device and a recording medium which can match a capability of position detection with a capability of image display.

The optical touch-panel device according to the present invention is an optical touch panel device comprising: a display section with a display screen; a position detecting section being provided with light emitting devices and light receiving devices arranged around the display screen, for detecting blocking of an optical path extending from one light emitting device to one or a plurality of the light receiving devices to detect a position of an object on the display screen, and for adjusting the number of light receiving devices which receives light emitted from the light emitting device to be able to detect the position at a plurality of kinds of position-detection resolutions; a screen resolution detecting section for detecting a screen resolution of the display screen; and a setting section for setting a position-detection resolution in the position detecting section according to the detected screen resolution.

The optical touch-panel device according to the present invention is characterized in that the setting section sets the position-detection resolution so that an average value of distances between adjacent optical paths over the whole display screen is smaller than a dot pitch according to the screen resolution and is as close as possible to the dot pitch.

The optical touch-panel device according to the present invention is characterized by further comprising: a menu control section for causing the display screen to display a menu image for selecting one position-detection resolution from the plurality of kinds of position-detection resolutions; and an accepting section for accepting the selected one position-detection resolution, wherein the setting section sets the selected one position-detection resolution.

The optical touch-panel device according to the present invention is characterized by further comprising: an image resolution detecting section for detecting an image resolution of an image to be displayed on the display screen, wherein the setting section sets the position-detection resolution in the position detecting section according to the detected image resolution when the image resolution does not match the screen resolution.

The optical touch-panel device according to the present invention is an optical touch panel device comprising: a display section with a display screen; a position detecting section being provided with light emitting devices and light receiving devices arranged around the display screen, for detecting blocking of an optical path extending from one light emitting device to one or a plurality of the light receiving devices to detect a position of an object on the display screen, and for adjusting the number of light receiving devices which receives light emitted from the light emitting device to be able to detect the position at a plurality of kinds of position-detection resolutions; an image resolution detecting section for detecting an image resolution of an image to be displayed on the display screen; and a setting section for setting a position-detection resolution in the position detecting section according to the detected image resolution.

The optical touch-panel device according to the present invention is characterized in that the setting section includes: a storage section storing information associating the position-detection resolution with an image resolution; and a resolution setting section for setting the position-detection resolution associated with the detected image resolution based on the information.

The optical touch-panel device according to the present invention is characterized in that the setting section sets the position-detection resolution so that an average value of distances between adjacent optical paths over the whole display screen is smaller than a pixel pitch according to the image resolution and is as close as possible to the pixel pitch.

The recording medium according to the present invention is a non-transitory recording medium in which a computer program is recorded, the computer program causing, a computer connected to an optical touch-panel unit provided with a display section including a display screen and with light emitting devices and light receiving devices arranged around the display screen, to execute a process of detecting a position of an object on the display screen in response to blocking of an optical path extending from one light emitting device to one or a plurality of the light receiving devices, said computer program comprising the steps of causing the computer to detect a screen resolution of the display screen; and causing the computer to make the optical touch-panel unit adjust the number of light receiving devices which receives light emitted from the light emitting device according to the detected screen resolution, to set a position-detection resolution.

The recording medium according to the present invention is a non-transitory recording medium in which a computer program is recorded, the computer program causing, a computer connected to an optical touch-panel unit provided with a display section including a display screen and with light emitting devices and light receiving devices arranged around the display screen, to execute a process of detecting a position of an object on the display screen in response to blocking of an optical path extending from one light emitting device to one or a plurality of the light receiving devices, said computer program comprising the steps of causing the computer to detect an image resolution of an image to be displayed on the display screen; and causing the computer to make the optical touch-panel unit adjust the number of light receiving devices which receives light emitted from the light emitting device according to the detected image resolution, to set a position-detection resolution.

In the present invention, the optical touch panel device can optically detect a position of an object on the display screen at a plurality of kinds of resolutions, and sets a position-detection resolution according to a screen resolution of the display screen or an image resolution of an image to be displayed on the display screen. Thereby, a capability of position detection matches a capability of image display on the display screen.

Moreover, in the present invention, the optical touch panel device associates an image resolution with a position-detection resolution in advance, detects an image resolution, and sets a position-detection resolution corresponding to the image resolution. Thereby, an appropriate position-detection resolution which matches an image resolution is set.

Moreover, in the present invention, the optical touch panel device sets a position-detection resolution so that an average value of distances between optical paths used for position detection over the whole display screen is smaller than a dot pitch or a pixel pitch and is as close as possible to the dot pitch or pixel pitch. The average value of distances between optical paths, which is smaller than the dot pitch or the pixel pitch, prevents an image corresponding to a written portion from being discontinuous or jagged. Also, the average value of distances between optical paths, which is close to the dot pitch or pixel pitch, leads to the controlled power consumption and the reduced response time.

Furthermore, in the present invention, the optical touch panel device accepts a selection of a position-detection resolution made by a user's operation, and sets the accepted position-detection resolution. Thereby, a position of a light shielding object is detected at a resolution according to a user's intention.

According to the present invention, a capability of position detection matches a capability of image display in the optical touch panel device, and a difference between a resolution of an image to be displayed on the display screen and a resolution of a write image does not bring a feeling of strangeness to a user. Since it is not necessary to set a resolution to be high wastefully, the present invention brings about an excellent effect, such as controlled power consumption, an improved responsibility, and the like, in the optical touch-panel device.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view showing an external appearance of an optical touch panel device of the present invention;

FIG. 2 is a block diagram showing internal configurations of an optical touch-panel unit and a process unit;

FIG. 3 is a schematic view showing configurations of a light emitting section and a light receiving section;

FIG. 4 is an explanatory diagram explaining a method for detecting a position in a whole scan method;

FIG. 5 is an explanatory diagram explaining a method for detecting a position in an intensive scan method;

FIG. 6 is a schematic view showing optical paths in three light receiving devices receiving infrared light emitted from one light emitting device;

FIG. 7 is a schematic view showing optical paths in five light receiving devices receiving infrared light emitted from one light emitting device;

FIG. 8 is a schematic view showing an extracted part of the optical paths in the three light receiving devices receiving infrared light emitted from the one light emitting device;

FIG. 9 is a schematic view showing an extracted part of the optical paths in the five light receiving devices receiving infrared light emitted from the one light emitting device;

FIG. 10 is a conceptual view indicating a relation between a screen resolution and a position-detection resolution;

FIG. 11 is a flow chart showing a procedure of a process of setting a position-detection resolution according to a screen resolution by the optical touch panel device;

FIG. 12 is a conceptual diagram showing a relation between an image resolution and a position-detection resolution; and

FIG. 13 is a flow chart showing a procedure of a process of setting a position-detection resolution according to an image resolution by the optical touch panel device.

### DETAILED DESCRIPTION

### Modes for Carrying Out Invention

Hereinafter, the present invention will be described in detail with reference to the drawings showing Embodiments thereof.

### Embodiment 1

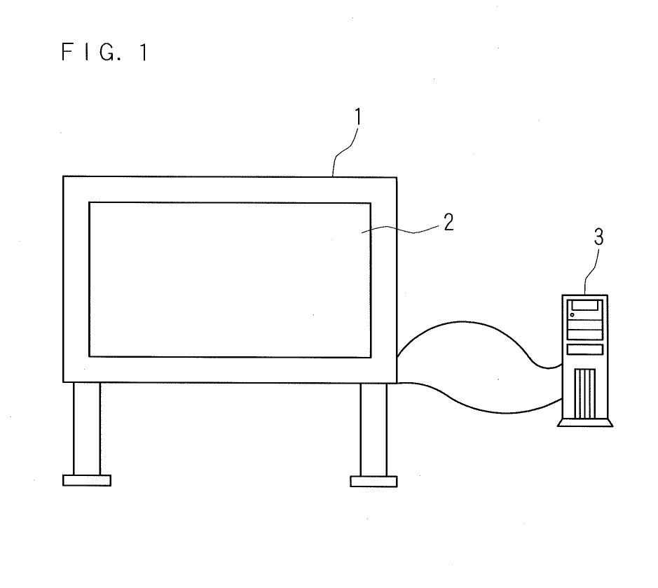

FIG. 1 is a schematic view showing an external appearance of an optical touch panel (an optical touch screen) device of the present invention. The optical touch panel device comprises an optical touch-panel unit 1 and a process unit 3 which executes processes using the optical touch-panel unit 1. The optical touch-panel unit 1 is connected to the process unit 3 via a communication line. The optical touch-panel unit 1 is provided with a rectangular display screen 2. A user puts a light shielding object, such as his/her finger or a pen, in any position on the display screen 2, and the optical touch panel device executes a process of detecting a position of the light shielding object put on the display screen 2. The process unit 3 is a computer, such as a PC (a personal computer).

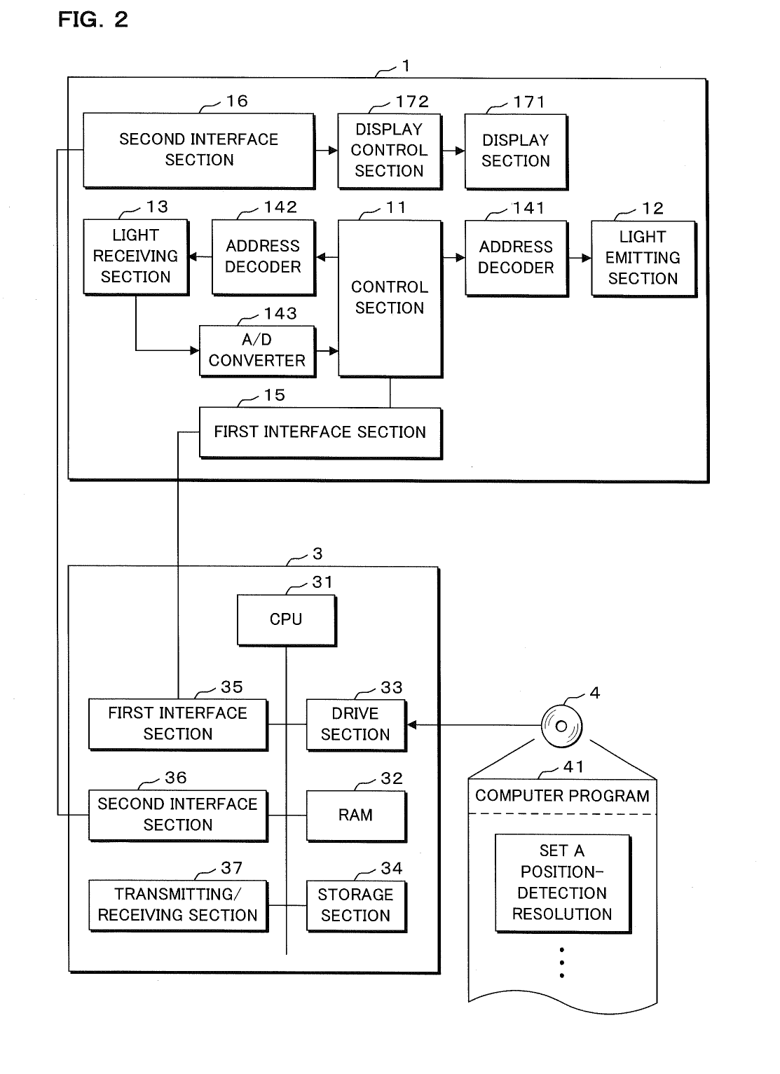

FIG. 2 is a block diagram showing internal configurations of the optical touch-panel unit 1 and the process unit 3. The optical touch-panel unit 1 is provided with a control section 11. The control section 11 is provided with a memory which stores control programs required for operations of the optical touch-panel unit 1, an operation section which executes operations, a memory which stores temporary data for operation, and the like. The optical touch-panel unit 1 is provided with a light emitting section 12 including a plurality of light emitting devices and a light receiving section 13 including a plurality of light receiving devices. The light emitting section 12 is connected to an address decoder 141, and the address decoder 141 is connected to the control section 11. The light receiving section 13 is connected to an address decoder 142, and the address decoder 142 is connected to the control section 11. Also, the light receiving section 13 is connected to an A/D converter 143, and the A/D converter 143 is connected to the control section 11. A first interface section 15 is connected to the control section 11. The control section 11 inputs/outputs data to/from the process unit 3 via the first interface section 15. The first interface section 15 is an interface section using a USB (Universal Serial Bus), for example.

The optical touch-panel unit 1 is provided with a rectangular display section 171 including an image display panel, such as a liquid crystal panel or an EL (electroluminescence) panel, and with a display control section 172 which controls the display section 171 to cause a display screen 2 of the display section 171 to display an image. The display section 171 is connected to the display control section 172, and the display control section 172 is connected to a second interface section 16. The second interface section 16 is an interface section using a HDMI (registered trademark) (High-Definition Multimedia Interface), for example. An image displayed by the display section 171 is displayed on the display screen 2, and a user can visually recognize an image displayed on the display screen 2.

The process unit 3 is provided with a CPU (Central Processing Unit) 31 which executes operations, a RAM (Random Access Memory) 32 which stores temporary information created for operation, a drive section 33 such as a CD-ROM drive, which read information from a recording medium 4 of the present invention such as an optical disk, and a storage section 34 such as a hard disk. The CPU 31 causes the drive section 33 to read a computer program 41 of the present invention from the recording medium 4 and causes the storage section 34 to store the read computer program 41. The computer program 41 is loaded from the storage section 34 to the RAM 32 if necessary, and the CPU 31 executes processes required for the optical touch panel device based on the loaded computer program 41. The storage section 34 stores data required for processes which the CPU 31 should execute. Also, the storage section 34 stores various kinds of setting data for controlling the optical touch panel device.

The process unit 3 is provided with a first interface section 35 and a second interface section 36. The first interface section 35 is connected to the first interface section 15 of the optical touch-panel unit 1 via a signal line, and the second interface section 36 is connected to the second interface section 16 of the optical touch-panel unit 1 via a signal line. The control section 11 transmits data required for detecting a position of a light shielding object on the display screen 2 from the first interface section 15 to the process unit 3, and the process unit 3 receives the data via the first interface section 35. The CPU 31 creates image data representing an image to be displayed on the display section 171, and transmits the created image data from the second interface section 36 to the optical touch-panel unit 1. The optical touch-panel unit 1 receives the image data via the second interface section 16, and the display control section 172 causes the display section 171 to display an image based on the received image data.

The process unit 3 is provided with a transmitting/receiving section 37 which transmits/receives data to/from a communication network or an external device which is not illustrated. The process unit 3 can transmit image data received by the transmitting/receiving section 37 to the touch panel section 1, and in the touch panel section 1, the display section 171 displays an image based on the image data. For example, the display section 171 displays a capture image captured by a camera, a scan image obtained by scanning a document with a scanner, or an image downloaded via a communication network.

The process unit 3 executes a process of detecting a position of a light shielding object on the display screen 2 based on a later-described process. Also, the process unit 3 creates image data representing an image in which a history of detected positions is shown with a line, and executes a process of causing the display section 171 to display an image based on the created image data. By this process, the display section 171 displays an image in which a locus of a light shielding object on the display screen 2 is shown with a line. That is, a write image representing a character or a drawing which a user writes on the display screen 2 using the light shielding object is displayed on the display screen 2. The process unit 3 can create image data representing an image in which a plurality of images overlap each other, and can execute a process of causing the display section 171 to display an image based on the created image data. By this process, an image in which a character is written in a scan image is displayed on the display screen 2, for example.

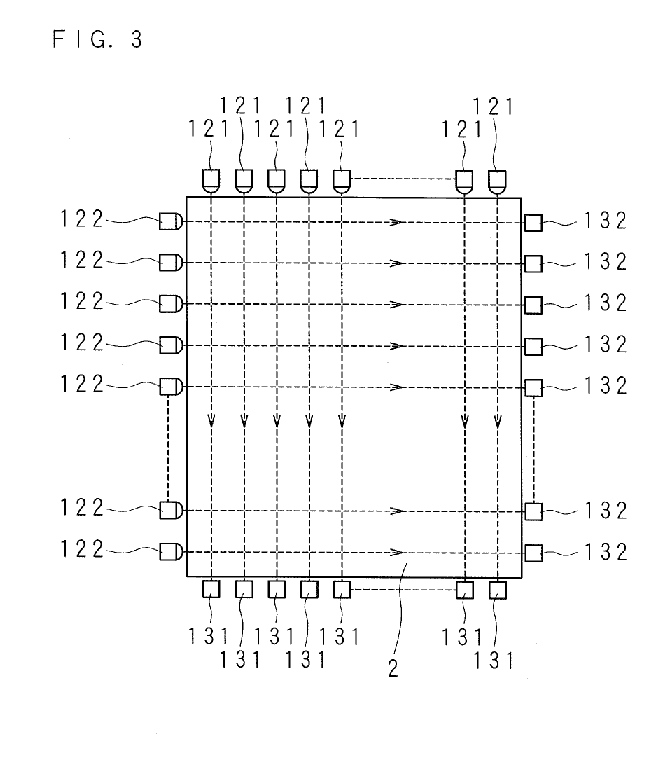

FIG. 3 is a schematic view showing configurations of the light emitting section 12 and the light receiving section 13. Along one side of the rectangular display screen 2, a plurality of light emitting devices 121, 121, . . . are aligned. Each of the light emitting devices 121 is a light emitting diode (LED) which emits infrared light. It is assumed that a direction in which the plurality of light emitting devices 121, 121, . . . are aligned is an X-axis direction of the display screen 2. Along one side adjacent to the one side, a plurality of light emitting devices 122, 122, . . . are aligned that are LEDs which emit infrared light. It is assumed that a direction in which the plurality of light emitting devices 122, 122, . . . are aligned is an Y-axis direction of the display screen 2. The light emitting section 12 is provided with the light emitting devices 121, 121, . . . and the light emitting devices 122, 122, . . . . The light emitting section 12 is provided with a multiplexer which is not illustrated, and each of the light emitting devices 121, 121, . . . and the light emitting devices 122, 122, . . . is connected to the multiplexer. Note that the light emitting section 12 may be provided with light emitting devices other than LEDs which emit infrared light.

Along a side facing the side of the display screen 2 where the plurality of light emitting devices 121, 121, . . . are aligned, a plurality of light receiving devices 131, 131, . . . are aligned. That is, the light receiving devices 131, 131, . . . are aligned in the X-axis direction. Each of the light receiving devices 131 is photodiode which receives infrared light. The light receiving devices 131, 131, . . . respectively face the light emitting devices 121, 121, . . . on the one-to-one basis. Along a side facing the side of the display screen 2 where the plurality of light emitting devices 122, 122, . . . are aligned, a plurality of light receiving devices 132, 132, . . . are aligned. That is, the light receiving devices 132, 132, . . . are aligned in the Y-axis direction. The light receiving devices 132, 132, . . . respectively face the light emitting devices 122, 122, . . . on the one-to-one basis. The light receiving devices 132 are photodiodes which receive infrared light. The light receiving section 13 is provided with the light receiving devices 131, 131, . . . and the light receiving devices 132, 132, . . . . The light receiving section 13 is provided with a multiplexer which is not illustrated, and each of the light receiving devices 131, 131, . . . and the light receiving devices 132, 132, . . . is connected to the multiplexer.

FIG. 3 shows, with a dashed line, optical paths in the light emitting devices emitting infrared light and the light receiving devices respectively facing the light emitting devices on the one-to-one basis receiving the infrared light. The light emitting devices 121, 121, . . . and the light receiving devices 131, 131, . . . are arranged so that optical paths are parallel to each other at equal intervals along the display screen 2 when the light emitting devices 121 and the light receiving devices 131 emit and receive light respectively on the one-to-one basis. Similarly, the light emitting devices 122, 122, . . . and the light receiving devices 132, 132, . . . are arranged so that optical paths are parallel to each other at equal intervals along the display screen 2 when the light emitting devices 122 and the light receiving devices 132 emit and receive light respectively on the one-to-one basis.

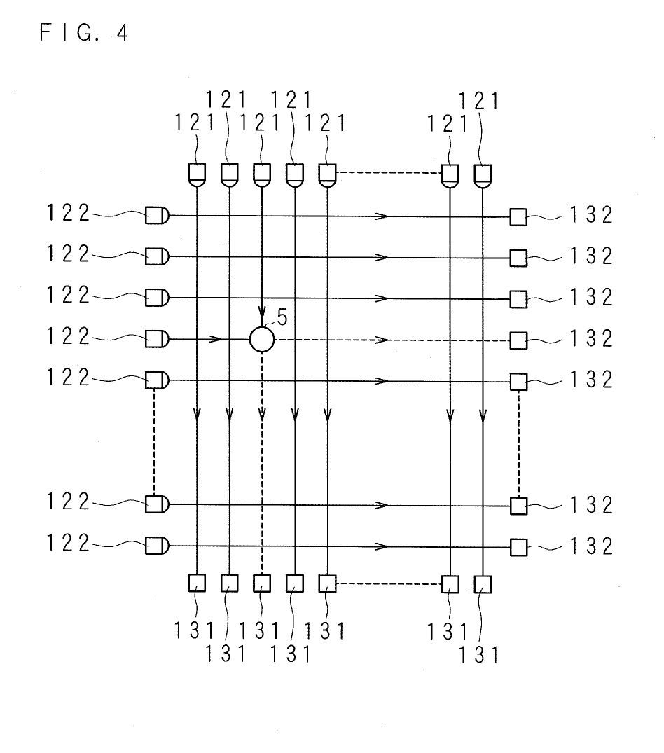

FIG. 4 is an explanatory diagram explaining a method for detecting a position in a whole scan method. The control section 11 outputs to the address decoder 141 a signal for scanning the plurality of light emitting devices sequentially, and outputs to the address decoder 142 a signal for scanning the plurality of light receiving devices sequentially. The address decoder 141 outputs, to the light emitting section 12, a signal for selecting any of the light emitting devices 121, 121, . . . and the light emitting devices 122, 122, . . . , according to the signal outputted from the control section 11. The address decoder 142 outputs, to the light receiving section 13, a signal for selecting a light receiving device facing the selected light emitting device on the one-to-one basis from the light receiving devices 131, 131, . . . and the light receiving devices 132, 132, . . . , according to the signal outputted from the control section 11. The selected light emitting device emits infrared light, and the selected light receiving device receives the infrared light and outputs to the A/D converter 143 an intensity signal indicating an intensity of the received infrared light at a voltage value. The A/D converter 143 converts the intensity signal outputted from the light receiving device into an 8-bit digital signal, for example, and outputs the converted intensity signal to the control section 11. The control section 11 sequentially repeats a process of obtaining an intensity signal from each light receiving device so as to obtain intensity signals from all the light receiving devices. For example, the control section 11 causes the light emitting devices 121, 121, . . . to emit light sequentially from an end, and obtains intensity signals from the light receiving devices facing the light emitting devices respectively. Then, the control section 11 causes the light emitting devices 122, 122, . . . to emit light sequentially from an end, and obtains intensity signals from the light receiving devices facing the light emitting devices respectively. FIG. 4 shows optical paths with solid arrows.

The control section 11 transmits sequentially from the first interface section 15 to the process unit 3 data indicating a result of light received by each light receiving device according to the intensity signal outputted from each light receiving device. At this time, data indicating coordinates of each light receiving device is transmitted together with the result of light received by each light receiving device. Note that the process unit 3 may store the data indicating coordinates of each light receiving device in the storage section 34 and the control section 11 may transmit data for identifying each light receiving device. The process unit 3 receives data outputted from the optical touch-panel unit 1 via the first interface section 35. The CPU 31 calculates an amount of light received by each light receiving device based on the received data. When the amount of light received by a certain light receiving device exceeds a predetermined threshold, the CPU 31 determines that the infrared light received by the light receiving device is not blocked. When the amount of light received by a certain light receiving device is not larger than the predetermined threshold, the CPU 31 determines that the infrared light to be received by the light receiving device is blocked. Thus, the CPU 31 identifies the light receiving device, infrared light to be received by said light receiving device being blocked. When a light shielding object 5, such as a user's finger or a pen, exists at any position on the display screen 2, an optical path passing through the position of the light shielding object 5 is blocked. FIG. 4 shows optical paths with solid arrows and shows optical paths blocked by the light shielding object 5 with dashed arrows. The CPU 31 determines a position of the light shielding object 5 corresponding to the identified light receiving device. For example, when amounts of light received by the light receiving device 131 existing at a position of coordinates (xi, 0) and the light receiving device 132 existing at a position of coordinates (0, yi) are not larger than a threshold and amounts of light received by the other light receiving devices exceeds the threshold, the CPU 31 determines that coordinates of a position of the light shielding object 5 are (xi, yi).

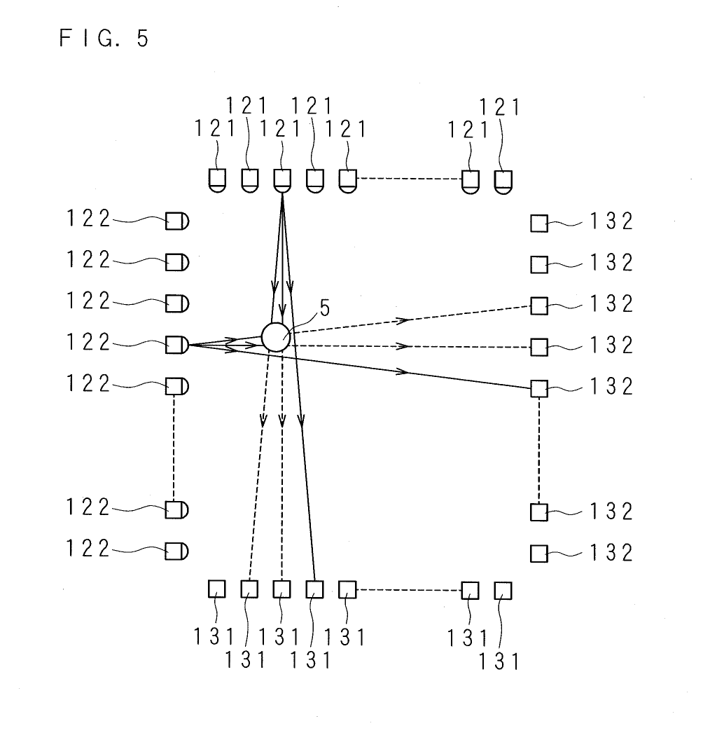

FIG. 5 is an explanatory diagram explaining a method for detecting a position in an intensive scan method. The optical touch panel device detects a position of a light shielding object 5 in the whole scan method, and then detects the position of the light shielding object 5 in the intensive scan method in order to detect the position of the light shielding object 5 at a higher resolution. The CPU 31 transmits, from the first interface section 35 to the optical touch-panel unit 1, data indicating the position of the light shielding object 5 detected in the whole scan method and instructions on a start of intensive scan. The optical touch-panel unit 1 receives the data indicating the position of the light shielding object 5 and the instructions on the start of intensive scan via the first interface section 15. The control section 11 identifies a light emitting device and a plurality of light receiving devices close to the light shielding object 5 based on the data indicating the position of the light shielding object 5, outputs a signal for designating the identified light emitting device to the address decoder 141, and outputs a signal for designating the plurality of identified light receiving devices to the address decoder 142. The address decoder 141 outputs, to the light emitting section 12, a signal for selecting any of the light emitting devices 121, 121, . . . and the light emitting devices 122, 122, . . . , according to the signal outputted from the control section 11. The address decoder 142 outputs, to the light receiving section 13, a signal for selecting a plurality of light receiving devices from the light receiving devices 131, 131, . . . and the light receiving devices 132, 132, . . . , according to the signal outputted from the control section 11. For example, when the coordinates of the position of the light shielding object 5 are determined to be (xi, yi) in the whole scan method, a light emitting device 121 existing at a position facing the light receiving device 131 existing at the position of coordinates (xi, 0), and a light emitting device 122 existing at a position facing the light receiving device 132 existing at the position of coordinates (0, yi) are selected. In addition, three light receiving devices 131 of the light receiving device 131 existing at the position of coordinates (xi, 0) and of two light receiving devices 131 adjacent to the light receiving device, and three light receiving devices 132 of the light receiving device 132 existing at the position of coordinates (0, yi) and of two light receiving devices 132 adjacent to the light receiving device are selected.

The selected light emitting device emits infrared light, and the plurality of selected light receiving devices receive the infrared light. Each light receiving device outputs to the A/D converter 143 an intensity signal indicating an intensity of the received infrared light at a voltage value, and the A/D converter 143 outputs the intensity signal to the control section 11. FIG. 5 shows optical paths with solid arrows and shows optical paths blocked by the light shielding object 5 with dashed arrows. As shown in FIG. 5, in the intensive scan method, a plurality of optical paths are not parallel to each other but are radial.

The control section 11 transmits, from the first interface section 15 to the process unit 3, data indicating a result of light received by each light receiving device according to the intensity signal outputted from each light receiving device. The process unit 3 receives data outputted from the optical touch-panel unit 1 via the first interface section 35. Based on the received data, the CPU 31 calculates an amount of light received by each light receiving device, determines whether or not each of the plurality of optical paths is blocked, and identifies a light receiving device, an optical path of infrared light to be received by said light receiving device being blocked, among the plurality of selected light receiving devices. The CPU 31 determines a position of the light shielding object 5 corresponding to the identified light receiving device. Since, as shown in FIG. 5, a distance between optical paths is shorter than that in the whole scan method, the optical touch panel device can detect a position of the light shielding object 5 at a higher resolution. Since a time required for scan is prolonged in a case where the whole display screen 2 is scanned in the intensive scan method, the optical touch panel device roughly detects a position of the light shielding object 5 in the whole scan method, and then scans the limited area around the position of the light shielding object 5 in the intensive scan method. When the CPU 31 detects a position in the intensive scan method, it can execute a process of adjusting the number of the light receiving devices which receive infrared light emitted from one light emitting device.

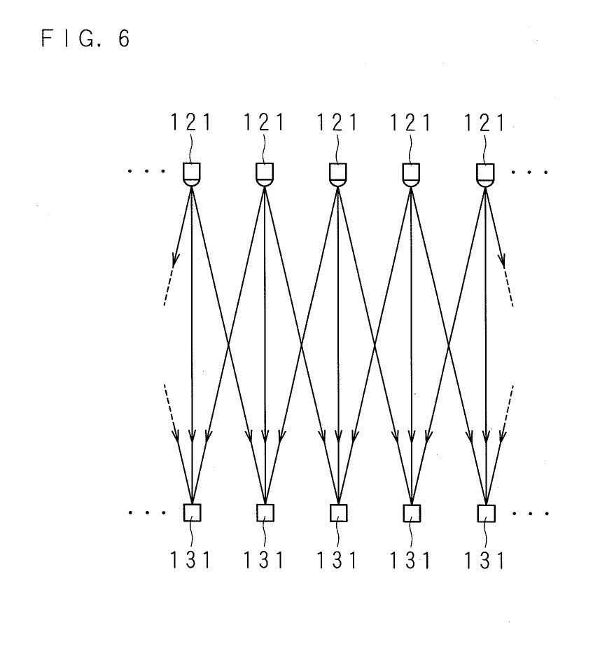

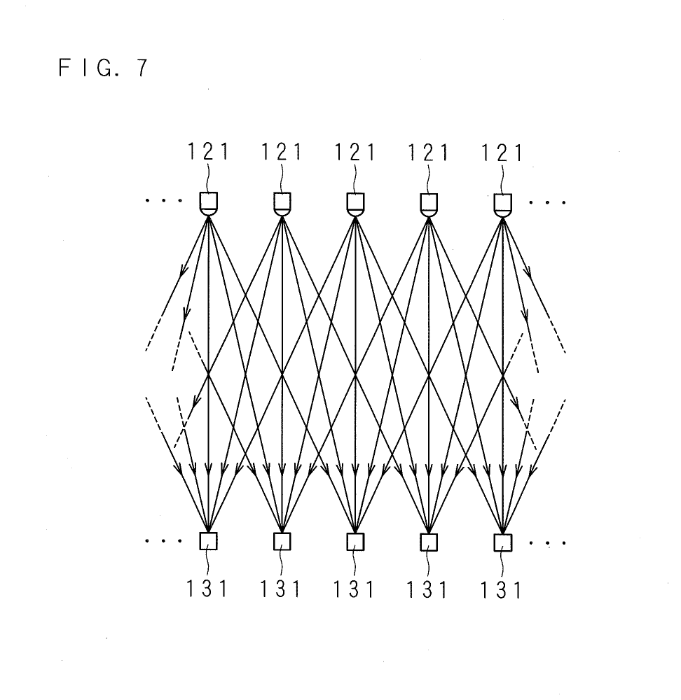

FIG. 6 is a schematic view showing optical paths in three light receiving devices 131 receiving infrared light emitted from one light emitting device 121, and FIG. 7 is a schematic view showing optical paths in five light receiving devices 131 receiving infrared light emitted from one light emitting device 121. FIGS. 6 and 7 show a part of the light emitting devices 121, 121, . . . and a part of the light receiving devices 131, 131, . . . . Also, they show, with solid arrows, optical paths of infrared light which is emitted by the one light emitting device 121 and are received by the three or five light receiving devices 131. In fact, optical paths of infrared light which are emitted by the light emitting devices 122 and are received by the light receiving devices 132 further crosses the illustrated optical paths. A resolution for detecting a position of the light shielding object 5 depends on a distance between optical paths. Specifically, the smaller a distance between optical paths is, the higher the resolution is. A distance between optical paths shown in FIG. 7 is smaller than a distance between optical paths shown in FIG. 6. Thus, the larger the number of light receiving devices which receive infrared light emitted from one light emitting device is, the smaller a distance between optical paths is. Therefore, the larger the number of light receiving devices which receive infrared light emitted from one light emitting device is, the higher a position-detection resolution is. On the other hand, the larger the number of light receiving devices which receive infrared light emitted from one light emitting device is, the larger the power consumption is and the slower the response speed is. The CPU 31 adjusts the number of light receiving devices which receive infrared light emitted from one light emitting device to change a position-detection resolution. That is, the optical touch panel device can detects a position at a plurality of kinds of resolutions.

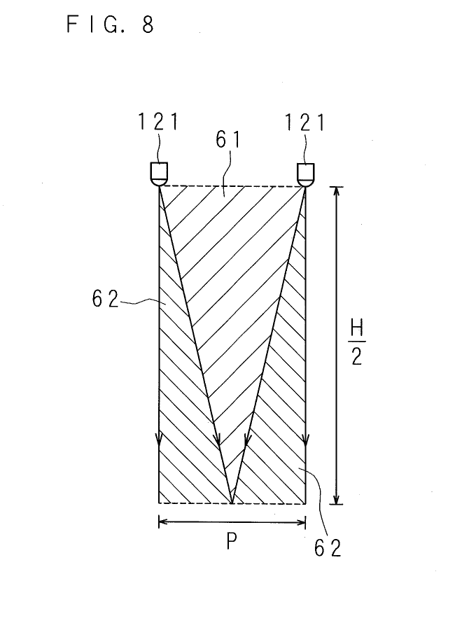

Next, the following description will explain a relation between a position-detection resolution and the number of light receiving devices which receive infrared light emitted from one light emitting device. FIG. 8 is a schematic view showing an extracted part of optical paths in the three light receiving devices 131 receiving infrared light emitted from the one light emitting device 121. In FIG. 8, a rectangular region surrounded by a half portion in the Y-axis direction and by a portion located between the light emitting devices 121 adjacent to each other in the X-axis direction is extracted from the display screen 2. The display screen 2 consists of many combinations of the extracted rectangular regions. It is assumed that a length of the Y-axis direction of the display screen 2 is H, and a distance between the adjacent light emitting devices 121 is P. The extracted rectangular region consists of one triangular region 61 and two triangular regions 62. Within the triangular region 61, an average of distances between optical paths in the X-axis direction is P/2. Within the triangular region 62, an average of distances between optical paths in the X-axis direction is P/4. A position-detection resolution is defined as a value obtained by weighting an average of distances between optical paths in each triangular region with an area of each triangular region and then averaging the weighted averages. The smaller a value of a resolution is, the higher the resolution is. An area of the extracted rectangular region is PH/2, an area of the triangular region 61 is PH/4, and an area of the triangular region 62 is PH/8. Therefore, a resolution in the X-axis direction within the extracted rectangular region is calculated to be (PH/4×P/2+2×PH/8×P/4)/(PH/2)=3P/8. In a case of P=4 mm, a resolution is set to be 1.5 mm.

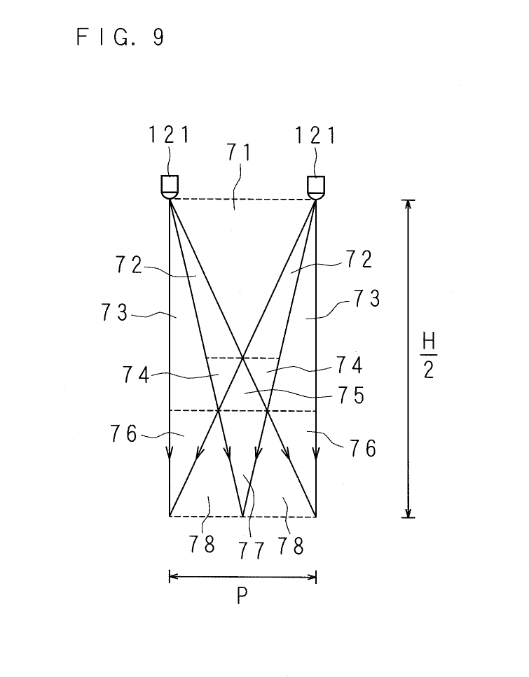

FIG. 9 is a schematic view showing an extracted part of optical paths in the five light receiving devices 131 receiving infrared light emitted from the one light emitting device 121. In FIG. 9, a rectangular region surrounded by a half portion in the Y-axis direction and a portion located between light emitting devices 121 adjacent to each other in the X-axis direction is extracted from the display screen 2. The extracted rectangular region consists of one triangular region 71, two triangular regions 72, two triangular regions 73, two triangular regions 74, one triangular region 75, two triangular regions 76, one triangular region 77 and two triangular regions 78. Based on a similar calculation method, a resolution in the X-axis direction within the rectangular region is calculated to be 37P/144. In a case of P=4 mm, a resolution is set to be 1.02 mm.

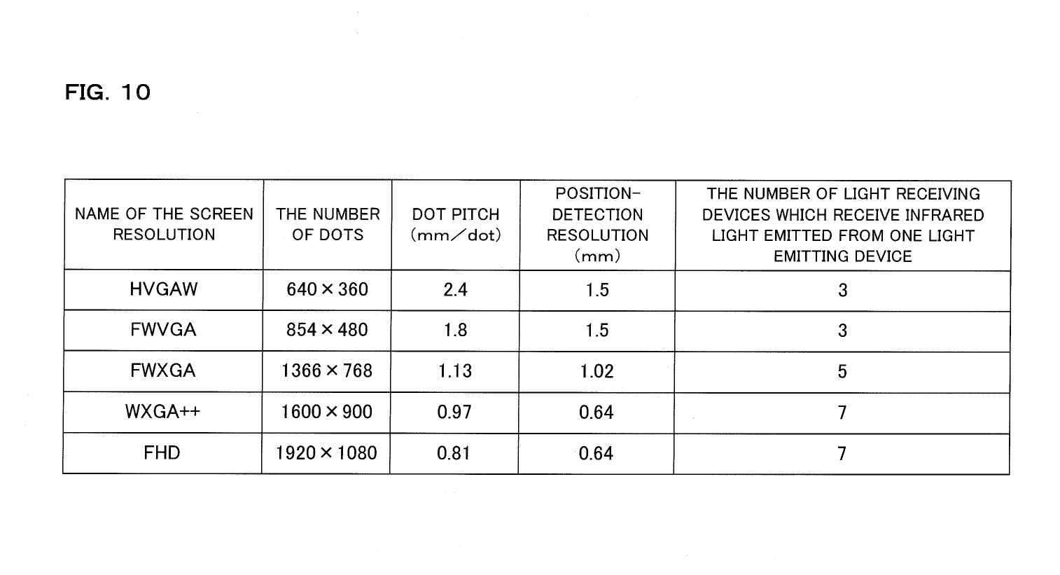

In the present invention, the optical touch panel device executes a process of setting a position-detection resolution according to a screen resolution at the time of the display section 171 displaying an image. The process unit 3 sets a position-detection resolution so that the position-detection resolution represented with an average of distances between optical paths is smaller than a dot pitch according to a screen resolution and is as close as possible to the dot pitch. In other words, the process unit 3 sets a position-detection resolution which is represented with an average of distances between optical paths, is smaller than a dot pitch according to a screen resolution and is regarded (determined) as being close to the dot pitch. FIG. 10 is a conceptual view indicating a relation between a screen resolution and a position-detection resolution. In FIG. 10, names of the screen resolution are associated with the number of dots in the X-axis direction and the Y-axis direction, with dot pitches in a screen size of 70 inches, with position-detection resolutions in a distance of P=4 mm between adjacent light emitting devices, and with the numbers of light receiving devices which receive infrared light emitted from one light emitting device. For example, in the screen resolution of the name of HVGAW (HalfVGA-Wide), the number of dots in the X-axis direction is 640, the number of dots in the Y-axis direction is 360, and the dot pitch on the display screen 2 in the screen size of 70 inches is 2.4 (mm/dot). In a case of P=4 mm, a position-detection resolution in the whole scan method is 4 (mm), a position-detection resolution in the intensive scan method is 1.5 (mm) in a case where the number of light receiving devices which receive infrared light emitted from one light emitting device is 3, and the larger the number of light receiving devices which receive infrared light emitted from one light emitting device is, the smaller a value of a resolution is. As shown in FIG. 10, since the value of the position-detection resolution is smaller than the dot pitch of HVGAW in a case where the number of light receiving devices which receive infrared light emitted from one light emitting device is 3, it is optimal to set the number of light receiving devices which receive infrared light emitted from one light emitting device to 3 in order to adjust the value of the position-detection resolution so as to be smaller than the dot pitch according to the screen resolution and be as close as possible to the dot pitch. Similarly, as shown in FIG. 10, the optimal number of light receiving devices which receive infrared light emitted from one light emitting device is set for the other screen resolutions. Note that FIG. 10 shows an example on a condition of the screen size of 70 inches and P=4 mm, and when the screen size of the display screen 2 or the distance between light emitting devices differs, a relation between the screen resolution and the position-detection resolution differs from the example of FIG. 10.

The storage section 34 stores information indicating a correspondence relation between the screen resolution and the position-detection resolution, as shown in FIG. 10. Note that the storage section 34 does not need to store the information indicating all the contents shown in FIG. 10, and may store information indicating a correspondence relation between the number of dots and the number of light receiving devices which receive infrared light emitted from one light emitting device, for example. The process unit 3 can execute a process of changing a screen resolution. For example, the CPU 31 causes the display section 171 to display a selection menu of a screen resolution using a function of OS (Operating System) for image display, accepts a selection of the screen resolution made by an operation using a user's light shielding object, and sets the selected screen resolution.

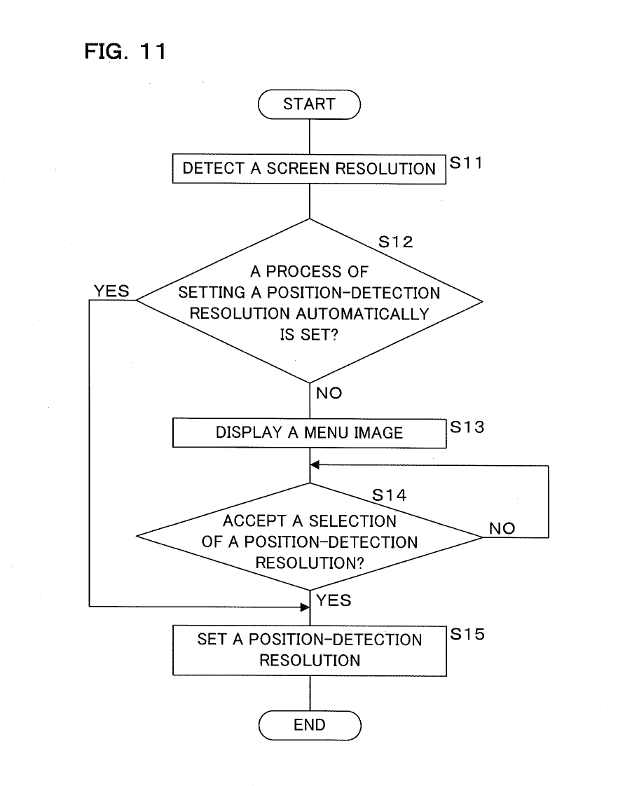

FIG. 11 is a flow chart showing a procedure of a process of setting a position-detection resolution according to a screen resolution by the optical touch panel device. The CPU 31 executes the following processes according to the computer program 41, when the optical touch panel device is started up or a screen resolution is changed. The CPU 31 detects a set screen resolution of the display section 171 (S11). In Step S11, the CPU 31 detects the screen resolution using an API (Application Programming Interface) contained in an OS, for example. When the OS is Windows (registered trademark), the CPU 31 can detect the screen resolution by using a GetSystemMetrics( ) function or a GetDeviceCaps( ) function which is the API of Windows (registered trademark).

Next, the CPU 31 refers to the setting data stored in the storage section 34 and determines whether or not a process of setting a position-detection resolution automatically is set (S12). Whether or not to set a position-detection resolution automatically is set in advance. The setting of whether or not to set a position-detection resolution automatically may be changed by a user's operation. When the process of setting a position-detection resolution automatically is not set (S12: NO), the CPU 31 causes the display section 171 to display a menu image for selecting one position-detection resolution from a plurality of kinds of position-detection resolutions (S13). The storage section 34 stores in advance image data representing a menu image tabulating a plurality of kinds of position-detection resolutions which are feasible in the optical touch panel device, and the CPU 31 causes the display section 171 to display an image based on the image data. Note that the CPU 31 may cause the display section 171 to display a menu image recommending one position-detection resolution corresponding to a screen resolution among a plurality of kinds of position-detection resolutions.

Then, the CPU 31 executes a process of waiting an acceptance of a selection of a position-detection resolution made using the menu image (S14). In Step S14, the touch panel section 1 and the process unit 3 detect a position of a light shielding object which points any position on the menu image by a user's operation, and accepts the selection of the position-detection resolution corresponding to the detected position. Note that a selection of a position-detection resolution made using a menu image may be executed based on a method other than the method of detecting a position of a light shielding object, such as a method of using a mouse. When there is no acceptance of a selection of a position-detection resolution (S14: NO), the CPU 31 continues the waiting. When there is an acceptance of a selection of a position-detection resolution (S14: YES), the CPU 31 sets the selected position-detection resolution as a position-detection resolution of the optical touch panel device (S15).

When the process of setting a position-detection resolution automatically is set (S12: YES), the CPU 31 refers to the information stored in the storage section 34 indicating the correspondence relation between the screen resolution and the position-detection resolution, and sets the position-detection resolution associated with the detected screen resolution as a position-detection resolution of the optical touch panel device (S15). Data indicating the set position-detection resolution is stored in the storage section 34. Subsequently, the optical touch panel device executes a process of detecting a position of a light shielding object on the display screen 2 at the set position-detection resolution.

When the optical touch panel device sets a position-detection resolution automatically, a capability of position detection of a light shielding object on the display screen 2 matches a capability of image display on the display screen 2. Compared with a screen resolution of the display screen 2, a position-detection resolution is not extremely low, and a write image corresponding to a detected position of a light shielding object is displayed at a similar resolution as that of the other image. Therefore, a user does not have a feeling of strangeness about a write image whose resolution is different from that of the other image. In addition, since a position-detection resolution is low when a screen resolution is low, the power consumption and the response time are not increased due to uselessly high position-detection resolution. Therefore, the power consumption of the optical touch panel device is controlled, and the responsibility of the optical touch panel device is improved.

In this Embodiment, a position-detection resolution is set so that the value of the position-detection resolution represented with an average of distances between optical paths over the whole display screen 2 is smaller than a dot pitch according to a screen resolution and is also as close as possible to the dot pitch. The value of a position-detection resolution smaller than a dot pitch can prevent a write image from being discontinuous or jagged. However, even if the value of a position-detection resolution is too small compared with a dot pitch, it is not reflected on a write image but the power consumption and the response time are merely increased. A position-detection resolution close to a dot pitch leads to the controlled power consumption and the reduced response time. Therefore, the optical touch panel device matches a capability of position detection with a capability of image display, and additionally the power consumption is controlled as low as possible and the responsibility is improved.

When a user selects a position-detection resolution, a position of a light shielding object is detected at a position-detection resolution according to a user's intention. For example, even when a screen resolution is low, an error of position detection is extremely small, and a write image, such as a character, is legible. Since a high position-detection resolution is unnecessary in a case where a rough drawing is drawn, for example, a position-detection resolution is lowered, thereby the power consumption can be controlled, and the responsibility can be improved.

Note that the optical touch panel device may have a form of always executing automatically a process of setting a position-detection resolution, or may have a form of always executing a process of accepting a selection of a position-detection resolution made by a user. Moreover, the optical touch panel device may have a form of not executing a process of changing a screen resolution. In this form, a position-detection resolution set automatically is fixed.

### Embodiment 2

In Embodiment 2, the following description will explain a form of setting a position-detection resolution according to an image resolution of an image to be displayed on the display screen 2. A screen resolution of the display screen 2 may not match an image resolution of an image to be displayed on the display screen 2. For example, when an image having an image resolution which matches a screen resolution is enlarged, the screen resolution does not change, but the image resolution changes to be lower than the screen resolution. An internal configuration of the optical touch panel device is the same as that in Embodiment 1.

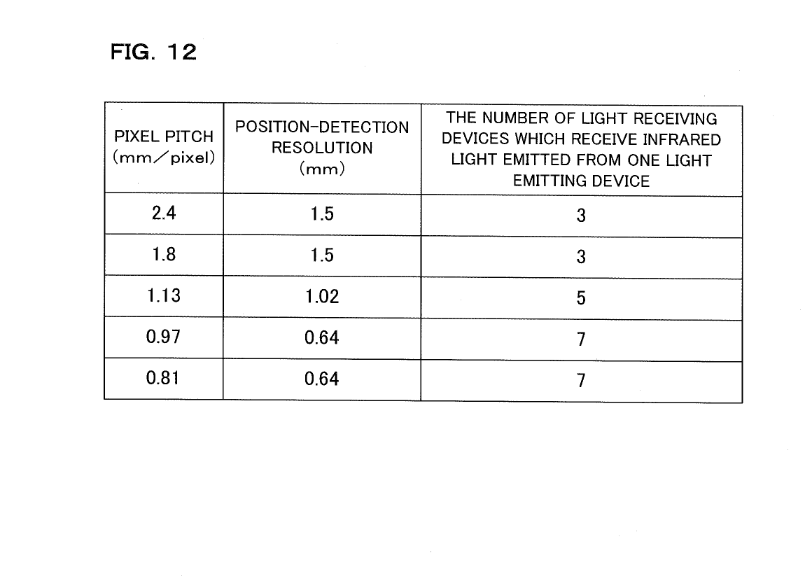

FIG. 12 is a conceptual diagram showing a relation between an image resolution and a position-detection resolution. In FIG. 12, pixel pitches in a screen size of 70 inches corresponding to a plurality of kinds of image resolutions are associated with values of position-detection resolutions in a distance of P=4 mm between adjacent light emitting devices, and with the numbers of light receiving devices which receive infrared light emitted from one light emitting device. For example, an image resolution in which a pixel pitch is set to 2.4 (mm/pixel) on the display screen 2 in a screen size of 70 inches is associated with a value of position-detection resolution of 1.5 (mm) in a case where the number of light receiving devices which receive infrared light emitted from one light emitting device is 3 in the intensive scan method. An image resolution is associated with a position-detection resolution so that the position-detection resolution represented with an average of distances between optical paths is smaller than a pixel pitch according to an image resolution and is as close as possible to the pixel pitch. In other words, an image resolution is associated with a position-detection resolution which is represented with an average of distances between optical paths, the position-detection resolution is smaller than a pixel pitch according to the image resolution and is regarded (determined) as being close to the pixel pitch. FIG. 12 shows an example on a condition of the screen size of 70 inches and the distance of P=4 mm between light emitting devices. When the screen size of the display screen 2 or the distance between light emitting devices differs, a relation between the image resolution and the position-detection resolution differs from the example in FIG. 12. The storage section 34 stores information indicating a correspondence relation between the image resolution and the position-detection resolution, as shown in FIG. 12.

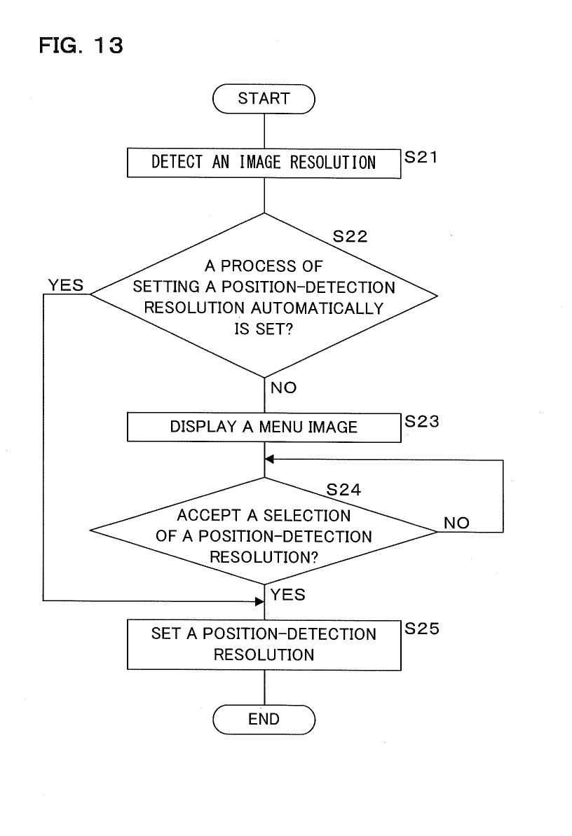

FIG. 13 is a flow chart showing a procedure of a process of setting a position-detection resolution according to an image resolution by the optical touch panel device. The CPU 31 executes the following processes according to the computer program 41, when the display section 171 displays an image or when an image resolution is changed. The CPU 31 detects an image resolution of an image to be displayed in the display section 171 (S21). In Step S21, the CPU 31 reads an image resolution contained in header information of image data, for example. Alternatively, the CPU 31 may calculate an image resolution from a pixel number contained in the image and a display size of the image. When executing a process of converting an image resolution by a complement of a pixel, etc., the CPU 31 detects the converted image resolution.

Next, the CPU 31 refers to the setting data stored in the storage section 34 and determines whether or not a process of setting a position-detection resolution automatically is set (S22). When the process of setting a position-detection resolution automatically is not set (S22: NO), the CPU 31 causes the display section 171 to display a menu image for selecting one position-detection resolution from a plurality of kinds of position-detection resolutions (S23). Then, the CPU 31 executes a process of waiting an acceptance of a selection of a position-detection resolution made using the menu image (S24). When there is no acceptance of a selection of a position-detection resolution (S24: NO), the CPU 31 continues the waiting. When there is an acceptance of a selection of a position-detection resolution (S24: YES), the CPU 31 sets the selected position-detection resolution as a position-detection resolution of the optical touch panel device (S25).

When the process of setting a position-detection resolution automatically is set in Step S22 (S22: YES), the CPU 31 refers to the information stored in the storage section 34 indicating the correspondence relation between the image resolution and the position-detection resolution, and sets the position-detection resolution associated with the detected image resolution as a position-detection resolution of the optical touch panel device (S25). Data indicating the set position-detection resolution is stored in the storage section 34. Subsequently, the optical touch panel device executes a process of detecting a position of a light shielding object on the display screen 2 at the set position-detection resolution. For example, when an image being displayed in the display section 171 is enlarged or reduced, or when an image resolution is changed under an influence of a transmission speed while displaying an image based on image data received via the interface section 15, an image resolution is changed and a position-detection resolution is changed.

Also in this Embodiment, when the optical touch panel device sets a position-detection resolution automatically, a capability of position detection of a light shielding object on the display screen 2 matches a capability of image display on the display screen 2. Compared with an image resolution, a position-detection resolution is not extremely low, and a user does not have a feeling of strangeness about a write image whose resolution is different from that of the other image. When an image resolution is low, a position-detection resolution is lowered, thereby the power consumption of the optical touch panel device is controlled and the responsibility of the optical touch panel device is improved.

Moreover, in this Embodiment, a position-detection resolution is set so that the value of the position-detection resolution represented with an average of distances between optical paths is smaller than a pixel pitch according to an image resolution and is as close as possible to the pixel pitch. A value of a position-detection resolution smaller than a pixel pitch prevents a write image from being discontinuous or jagged. A value of a position-detection resolution close to the pixel pitch leads to the controlled power consumption and the reduced response time. Therefore, the optical touch panel device matches a capability of position detection with a capability of image display, and additionally the power consumption is controlled as low as possible and the responsibility is improved. When a user selects a position-detection resolution, a position of a light shielding object is detected at a position-detection resolution according to a user's intention separately from an image resolution.

Note that the optical touch panel device may have a form of always executing automatically a process of setting a position-detection resolution, or may have a form of always executing a process of accepting a selection of a resolution made by a user. Moreover, the optical touch panel device may have a form of executing both of a process concerning Embodiment 1 and a process concerning Embodiment 2. For example, the optical touch panel device may have a form of setting a position-detection resolution according to a screen resolution at the time of startup, and setting a position-detection resolution according to an image resolution when displaying an image whose image resolution does not match a screen resolution.

Although in Embodiments 1 and 2, the form is described that the optical touch-panel unit 1 and the process unit 3 are provided with the two kinds of interface sections and are connected via the two communication lines, respectively, the optical touch-panel unit 1 and the process unit 3 may be provided with one kind of interface section and be connected via one communication line. Moreover, although in Embodiments 1 and 2, the form is described that the optical touch-panel unit 1 transmits to the process unit 3 a result of light received in a light receiving device, the optical touch-panel unit 1 may execute a process of detecting a position of a light shielding object 5 from a result of received light and transmitting information indicating a detected position to the process unit 3. Moreover, although in Embodiments 1 and 2, infrared light is used for position detection, the optical touch panel device may have a form of using light of the other wavelength. Furthermore, the optical touch panel device may have a form of not being provided with the process unit 3 but executing all the processes by the optical touch-panel unit 1.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-10. (canceled)

11. An optical touch panel device, comprising:
a display section with a display screen;
a position detecting section being provided with light emitting devices and light receiving devices arranged around the display screen, for detecting blocking of an optical path extending from one light emitting device to one or a plurality of the light receiving devices to detect a position of an object on the display screen, and for adjusting the number of light receiving devices which receives light emitted from the light emitting device to be able to detect the position at a plurality of kinds of position-detection resolutions;
a screen resolution detecting section for detecting a screen resolution of the display screen; and
a setting section for setting a position-detection resolution in the position detecting section according to the detected screen resolution.

12. The optical touch panel device according to claim 11, wherein
the setting section sets the position-detection resolution so that an average value of distances between adjacent optical paths over the whole display screen is smaller than a dot pitch according to the screen resolution and is as close as possible to the dot pitch.

13. The optical touch panel device according to claim 11, further comprising:
a menu control section for causing the display screen to display a menu image for selecting one position-detection resolution from the plurality of kinds of position-detection resolutions; and
an accepting section for accepting the selected one position-detection resolution,
wherein the setting section sets the selected one position-detection resolution.

14. The optical touch panel device according to claim 11, further comprising
an image resolution detecting section for detecting an image resolution of an image to be displayed on the display screen,
wherein the setting section sets the position-detection resolution in the position detecting section according to the detected image resolution when the image resolution does not match the screen resolution.

15. An optical touch panel device comprising:
a display section with a display screen;
a position detecting section being provided with light emitting devices and light receiving devices arranged around the display screen, for detecting blocking of an optical path extending from one light emitting device to one or a plurality of the light receiving devices to detect a position of an object on the display screen, and for adjusting the number of light receiving devices which receives light emitted from the light emitting device to be able to detect the position at a plurality of kinds of position-detection resolutions;
an image resolution detecting section for detecting an image resolution of an image to be displayed on the display screen; and
a setting section for setting a position-detection resolution in the position detecting section according to the detected image resolution.

16. The optical touch panel device according to claim 15, wherein the setting section includes:
a storage section storing information associating the position-detection resolution with an image resolution; and
a resolution setting section for setting the position-detection resolution associated with the detected image resolution based on the information.

17. The optical touch panel device according to claim 15, wherein
the setting section sets the position-detection resolution so that an average value of distances between adjacent optical paths over the whole display screen is smaller than a pixel pitch according to the image resolution and is as close as possible to the pixel pitch.

18. The optical touch panel device according to claim 16, wherein
the setting section sets the position-detection resolution so that an average value of distances between adjacent optical paths over the whole display screen is smaller than a pixel pitch according to the image resolution and is as close as possible to the pixel pitch.

19. The optical touch panel device according to claim 15, further comprising:
a menu control section for causing the display screen to display a menu image for selecting one position-detection resolution from the plurality of kinds of position-detection resolutions; and
an accepting section for accepting the selected one position-detection resolution,
wherein the setting section sets the selected one position-detection resolution.

20. A non-transitory recording medium in which a computer program is recorded, the computer program causing, a computer connected to an optical touch-panel unit provided with a display section including a display screen and with light emitting devices and light receiving devices arranged around the display screen, to execute a process of detecting a position of an object on the display screen in response to blocking of an optical path extending from one light emitting device to one or a plurality of the light receiving devices, said computer program comprising the steps of:
causing the computer to detect a screen resolution of the display screen; and
causing the computer to make the optical touch-panel unit adjust the number of light receiving devices which receives light emitted from the light emitting device according to the detected screen resolution, to set a position-detection resolution.

21. A non-transitory recording medium in which a computer program is recorded, the computer program causing, a computer connected to an optical touch-panel unit provided with a display section including a display screen and with light emitting devices and light receiving devices arranged around the display screen, to execute a process of detecting a position of an object on the display screen in response to blocking of an optical path extending from one light emitting device to one or a plurality of the light receiving devices, said computer program comprising the steps of:
causing the computer to detect an image resolution of an image to be displayed on the display screen; and
causing the computer to make the optical touch-panel unit adjust the number of light receiving devices which receives light emitted from the light emitting device according to the detected image resolution, to set a position-detection resolution.
